(19) United States
(12) Patent Application Publication
(10) Pub. No.: US 2023/0116257 A1
(43) Pub. Date: Apr. 13, 2023

(54) CONDUCTIVE MATERIAL DISPERSION FOR RECHARGEABLE LITHIUM BATTERY, NEGATIVE ELECTRODE PREPARED USING SAME, AND RECHARGEABLE LITHIUM BATTERY INCLUDING NEGATIVE ELECTRODE

(71) Applicant: Samsung SDI Co., Ltd., Yongin-si (KR)

(72) Inventors: Minjae Kim, Yongin-si (KR); Jongheon Seol, Yongin-si (KR); Junghyun Nam, Yongin-si (KR); Sungsoo Han, Yongin-si (KR)

(21) Appl. No.: 17/937,898

(22) Filed: Oct. 4, 2022

(30) Foreign Application Priority Data
Oct. 5, 2021 (KR) 10-2021-0131915

(51) Int. Cl. H01M 4/62; H01M 10/052; H01M 4/38; H01M 4/583

(52) U.S. Cl. CPC H01M 4/625; H01M 4/386; H01M 4/583; H01M 10/052; H01M 2004/021

(57) ABSTRACT

Disclosed is a conductive material dispersion for a rechargeable lithium battery, a negative electrode prepared using the same, and a conductive material dispersion including carbon nanotubes, wherein the conductive material dispersion has a viscosity of about 10,000 cps or less, and wherein in a graph showing a particle size distribution of the dispersion, when A is a maximum peak intensity shown in a range of a particle size of about 0.5 µm or less and B is a maximum peak intensity shown in a range of a particle size of less than about 0.5 µm, the A and the B satisfy the relationship of Equation 1.

$$\text{A} / \text{B} < 1$$

### CROSS-REFERENCE TO RELATED APPLICATION

This application claims priority to and the benefit of Korean Patent Application No. 10-2021-0131915 filed in the Korean Intellectual Property Office on Oct. 5, 2021, the entire contents of which are hereby incorporated by reference.

### BACKGROUND

### 1. Field

Embodiments of the present disclosure relate to a conductive material dispersion for a rechargeable lithium battery, a negative electrode prepared using the same, and a rechargeable lithium battery including the same.

### 2. Description of the Related Art

Recently, the rapid proliferation of electronic devices such as mobile phones, laptop computers, and electric vehicles using batteries require substantial or surprising increases in demands for rechargeable batteries having relatively high capacity and lighter weight. For example, a rechargeable lithium battery has recently drawn attention as a driving power source for portable devices, as it has lighter weight and high energy density. Accordingly, research for improving performances of rechargeable lithium is actively being conducted.

A rechargeable lithium battery includes a positive electrode and a negative electrode, which may include an active material being capable of intercalating and deintercalating lithium ions, and an electrolyte, and generates electrical energy due to an oxidation and reduction reaction when lithium ions are intercalated and deintercalated into the positive electrode and the negative electrode.

As for a positive active material of a rechargeable lithium battery, transition metal compounds such as lithium cobalt oxides, lithium nickel oxides, and lithium manganese oxides are mainly used. As the negative active material, a crystalline carbonaceous material such as natural graphite or artificial graphite, and/or an amorphous carbonaceous material, is used.

Nowadays, the negative active material layer has been thickly formed in order to improve the energy density of the rechargeable lithium battery, and especially, there have been attempts to prepare a negative active material layer in the form of a double layer using the silicon-based active material. However, this causes problems such as the breakdown of the negative electrode due to volume expansion and shrinkage of the silicon-based active material during charging and discharging.

The above information disclosed in this Background section is only for enhancement of understanding of the background of the subject matter of the present disclosure, and therefore, it may contain information that does not form the prior art that is already known in this country to a person of ordinary skill in the art.

### SUMMARY

One embodiment provides a conductive material dispersion for a rechargeable lithium battery exhibiting good energy density and cycle-life characteristics.

Another embodiment provides a negative electrode prepared using the conductive material dispersion.

Another embodiment provides a rechargeable lithium battery including the negative electrode.

One embodiment provides a conductive material dispersion for a rechargeable lithium battery including carbon nanotubes, wherein the conductive material dispersion has a viscosity of about 10,000 cps or less, and wherein in a graph showing a particle size distribution of the conductive material dispersion, when A is a maximum peak intensity shown in a range of a particle size of about 0.5 µm or less and B is a maximum peak intensity shown in a range of a particle size of less than about 0.5 µm, A and B satisfy the relationship of Equation 1.

$$\text{A} / \text{B} < 1$$

The A/B of Equation 1 may be about 0.2 to about 0.8.

The conductive material dispersion may have a viscosity of about 2000 cps to about 10,000 cps.

An amount of the carbon nanotubes may be about 0.4 wt% to about 2.0 wt% based on a total of 100 wt%, of the conductive material dispersion.

The carbon nanotubes may be single-walled carbon nanotubes, multi-walled carbon nanotubes, or a combination thereof.

The carbon nanotubes may have an average length of about 10 µm or less. The carbon nanotubes may have an average diameter of about 1 nm to about 5 nm.

The A may be about 0.1 volume% to about 15 volume% and the B may be about 1 volume% to about 20 volume%.

Another embodiment provides a negative electrode for a rechargeable lithium battery prepared by using the conductive material dispersion.

The negative electrode may include a silicon and carbon composite negative active material.

Another embodiment provides a rechargeable lithium battery including the negative electrode, a positive electrode, and an electrolyte.

The conductive material dispersion according to one embodiment may provide the negative electrode for a rechargeable lithium battery and the rechargeable lithium battery exhibiting high energy density and good cycle-life characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a graph illustrating a particle size distribution of a conductive material dispersion according to one embodiment.

FIG. 2 is a schematic view showing the structure of a lithium secondary battery according to an embodiment.

FIG. 3 is a graph showing the particle size distribution of the conductive material dispersion of Example 1 and Comparative Example 1.

### DETAILED DESCRIPTION

Hereinafter, embodiments of the present disclosure are described in more detail. However, these embodiments are examples, the present disclosure is not limited thereto, and the present disclosure is defined by the scope of the appended claims, and equivalents thereof.

In the present specification, a particle size may be the average particle diameter of the particles. In this case, the average particle diameter may mean a particle diameter (D50) measured as a cumulative volume. Such a particle diameter (D50) means the average particle diameter (D50), which means the diameter of particles having a cumulative volume of 50 volume% in the particle size distribution.

The average particle size (D50) may be measured by any suitable method generally used in the art, for example, by a particle size analyzer, a transmission electron microscopic image, or a scanning electron microscopic image. In some embodiments, a dynamic light-scattering measurement device is used to perform a data analysis, and the number of particles is counted for each particle size range. From this, the average particle diameter (D50) value may be easily obtained through a calculation.

A conductive material dispersion (e.g., a dispersion of an electrically conductive material) for a rechargeable lithium battery according to one embodiment may include carbon nanotubes.

In a graph showing a particle size distribution of the dispersion, when a maximum peak intensity occurring in the range of a particle size of about 0.5 µm or less is referred as A and a maximum peak intensity occurring in the range of particle size of more than about 0.5 µm is referred as B, the A and the B may satisfy the relationship of Equation 1.

$$\text{A} / \text{B} < 1$$

In one embodiment, the A/B of Equation 1 may be about 0.2 to about 0.8.

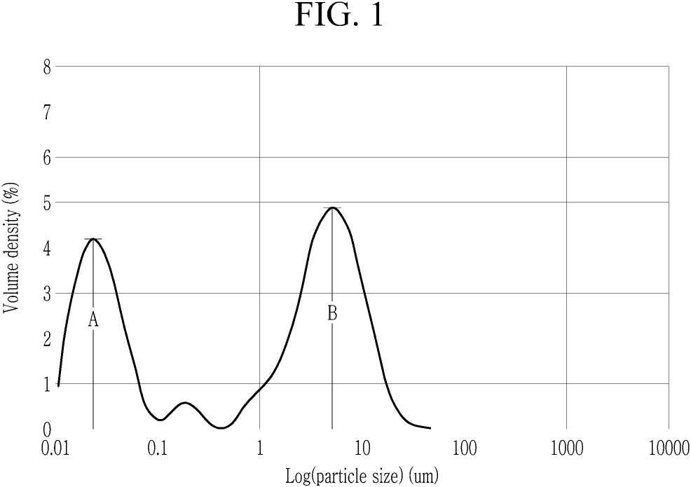

Example embodiments of the maximum peak value A and the maximum peak value B are illustrated in FIG. 1, and they are further described below. The particle sizes of the conductive material (e.g., the electrically conductive material) included in the dispersion are measured. When a log value of the particle size is considered as an X-axis and the volume density (as a percentage of the particles) is considered as a Y-axis, a height of the highest peak of the peaks occurring at 0.5 µm or less of the particle size is referred to as A, and a height of the highest peak of the peaks occurring at more than 0.5 µm of the particle size is referred to as B. The volume density indicates a volume distribution and, for example, indicates a volume percent in which particles having respective sizes shown in the X-axis of FIG. 1 are present in the dispersion.

Larger A and B values indicate that the particles having a set or predetermined size are largely distributed. In one embodiment, the A value may be about 0.1 volume% to 15 volume%, and the B value may be about 1 volume% to about 20 volume%. The A value may be about 0.2 volume% to about 12 volume%, or about 1 volume% to about 10 volume%. The B value may be about 1% to about 18 volume%, or about 2 volume% to about 15 volume%.

Embodiments of the particle size distribution satisfy the relationship of Equation 1 in the conductive material dispersion and have a distribution of fine particles and macroparticles that provides a suitable viscosity. For example, when the relationship of Equation 1 is satisfied, the conductive material is present in a bimodal form including fine particles and macroparticles, and may exhibit improved ability for producing (e.g., improved processability). Furthermore, such a conductive material may impart excellent conductivity to the active material, thereby exhibiting long cycle-life characteristics.

If the conductive material does not satisfy the relationship of Equation 1, e.g., A/B is more than 0.8, it is difficult to ensure long-range conductivity, which is conductivity at a widened gap between active materials, and the viscosity is substantially or severely increased, thereby deteriorating or reducing the ability for producing (e.g., reduced processability).

The conductive material dispersion may have a viscosity of about 10,000 cps or less, and according to one embodiment, may be about 1000 cps to about 10,000 cps. The viscosity indicates a value at room temperature (about 20° C. to about 25° C.). The viscosity of the conductive material dispersion of about 10,000 cps is a suitable or desired viscosity for coating, and the negative electrode may be readily prepared by using the conductive material dispersion, and thus, the improved ability for producing (e.g., improved processability) may be exhibited.

In the conductive material dispersion according to one embodiment, the carbon nanotubes are included as the conductive material, and an amount of the carbon nanotubes may be about 0.4 wt% to about 2.0 wt%, or about 0.5 wt% to about 1.5 wt% based on the total of 100 wt% of the conductive material dispersion. When the amount of the carbon nanotubes is within the above range, the conductive material dispersion having suitable viscosity may be obtained and a negative electrode exhibiting good electrode performances may be prepared using the conductive material dispersion.

The carbon nanotubes may be single-walled carbon nanotubes, multi-walled carbon nanotubes, or a combination thereof. According to one embodiment, the carbon nanotubes may be single-walled carbon nanotubes.

The carbon nanotubes may have an average diameter of about 1 nm to about 5 nm, or about 1 nm to about 2 nm. The diameter of carbon nanotubes indicates a length of a shorter axis perpendicular (or substantially perpendicular) to a longer axis. When the average diameter of carbon nanotubes is within the foregoing range, the conductivity (e.g., electrically conductivity) may be imparted to a wider volume (area), even with a small amount of the carbon nanotubes.

The carbon nanotubes may have an average length of about 10 µm or less, or about 0.1 µm to about 10 µm. When the average length of carbon nanotubes is satisfied in the foregoing range, the ability for impregnating the electrolyte to the electrode and mobility of ions in the battery may be improved for the electrode prepared by using the conductive material dispersion.

The conductive material dispersion may further include a dispersing agent. An amount of the dispersing agent may be about 0.6 wt% to about 2.5 wt%, or about 1 wt% to about 2.3 wt% based on the total of 100 wt% of the conductive material dispersion.

The dispersing agent may be polyvinyl pyrrolidone, sodium dodecylbenzene sulfonate, carboxymethyl cellulose, or a combination thereof.

The conductive material dispersion may include water as a solvent.

Furthermore, the conductive material dispersion may further include an additional solvent. The additional solvent may be selected from an amide-based polar organic solvent such as dimethyl formamide, diethyl formamide, dimethyl acetamide (DMAc), N-methyl pyrrolidone (NMP), and the like; alcohols such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentenol, hexanol, heptanol, octanol, and the like; glycols such as ethylene glycol, diethylene glycol, triethylene glycol, propylene glycol, 1,3-propanediol, 1,3-butanediol, 1,5-pentanediol, hexylene glycol, and the like; polyhydric alcohols such as glycerine, trimethylolpropane, pentaerythritol, sorbitol, and the like; glycol ethers such as ethylene glycol monomethyl ether, diethylene glycol monomethyl ether, triethylene glycol monomethyl ether, tetra ethylene glycol monomethyl ether, ethylene glycol monoethyl ether, diethylene glycol monoethyl ether, triethylene glycol monoethyl ether, tetra ethylene glycol monoethyl ether, ethylene glycol monobutyl ether, diethylene glycol monobutyl ether, triethylene glycol monobutyl ether, tetra ethylene glycol monobutyl ether, and the like; ketones such as acetone, methyl ethyl ketone, methylpropyl ketone, cyclopentanone, and the like; esters such as ethyl acetate, y-butyl lactone, ε-propinolactone, and the like, and a mixture of one or more thereof.

The conductive material dispersion may be prepared by adding carbon nanotubes as the conductive material, and optionally, the dispersing agent in the solvent and dispersing them. Herein, the dispersion may be performed for about 1 hour to about 24 hours. When the dispersion is performed for the foregoing range of time, the dispersion of carbon nanotubes is less occurred (e.g., the carbon nanotubes are less dispersed) so that the particles having large particle sizes are largely present, thereby decreasing the peak intensity occurring in the range of particle sizes of about 0.5 µm or less. This causes a reduction in the viscosity of the conductive material dispersion, and thus, the ability for producing the negative electrode using the same may be improved and the cycle-life characteristics may be improved.

The dispersion including the conductive material may have a concentration of about 0.5 wt% to about 5 wt% (e.g., about 0.5 wt% to about 5 wt% of the conductive material may be included in the dispersion based on the total weight of the dispersion). The concentration of the dispersion including the conductive material within the foregoing range prevents or reduces shortcomings related to a lack of movement or reduced flow due to high viscosity during coating, which results in a low content of solids, thereby improving non-uniformity (quality) of the negative electrode during coating.

The negative electrode according to one embodiment may be prepared by using the conductive material dispersion. For example, the conductive material dispersion, a negative active material, a binder, and a solvent are mixed together to prepare a composition for a negative active material layer, and the composition is coated on a current collector and dried followed by pressing a negative electrode. The prepared negative electrode includes a negative active material layer including the negative active material, the conductive material and the binder, and the current collector.

The negative active material may be a silicon-based active material which is a composite of silicon and carbon.

The composite of silicon and carbon may include Si particles and a first carbon-based material. The first carbon-based material may be amorphous carbon and/or crystalline carbon. Examples of the composite may include, for example, a core in which Si particles and a second carbon-based material are mixed together and a third carbon-based material on and at least partially surrounding the core. The second carbon-based material and the third carbon-based material may be the same as or different from each other, and may be amorphous carbon and/or crystalline carbon.

The amorphous carbon may be pitch carbon, soft carbon, hard carbon, mesophase pitch carbide, sintered cokes, carbon fiber, or a combination thereof, and the crystalline carbon may be artificial graphite, natural graphite, or a combination thereof.

The Si particles may have a particle diameter of about 10 nm to about 30 µm, and according to one embodiment, may be about 10 nm to about 1000 nm, or according to another embodiment, may be about 20 nm to about 150 nm. When the average particle diameter of the Si particles is within the foregoing range, the volume expansion caused during charging and discharging may be inhibited or reduced and the disconnection of the conductive path due to particle breakage during charging and discharging may be prevented or reduced.

When the composite of the Si particles and carbon includes the Si particles and the first carbon-based material, an amount of the Si particles may be about 30 wt% to about 70 wt%, or according to one embodiment, may be about 40 wt% to about 50 wt% (e.g., based on the total weight of the composite). An amount of the first carbon-based material may be about 70 wt% to about 30 wt%, or according to one embodiment, may be about 60 wt% to about 50 wt% (e.g., based on the total weight of the composite). When the amounts of the Si particles and the first carbon-based material are within the foregoing range, high-capacity characteristics may be exhibited.

When the composite of the Si particles and carbon includes a core in which the Si particles and the second carbon-based material are mixed together and a third carbon-based material on and at least partially surrounding the core, the third carbon-based material may be present in a thickness of about 5 nm to about 100 nm. The third carbon-based material may be present in an amount of about 1 wt% to about 50 wt% based on a total of 100 wt% of the Si-based material, the Si particles may be presented in an amount of 30 wt% to 70 wt% based on a total of 100 wt% of the Si-based material and the second carbon-based material may be present in an amount of about 20 wt% to about 69 wt% based on a total of 100 wt% of the Si-based material. When the amounts of the Si particles, the third carbon-based material, and the second carbon-based material satisfy the foregoing range, the discharge capacity may be excellent and capacity retention may be improved.

The negative active material may further include a carbon-based active material together with the silicon-based active material. The carbon-based active material may be artificial graphite, natural graphite, or a combination thereof.

In a case of further including the carbon-based active material in the negative active material, the mixing ratio of the carbon-based active material and the silicon-based active material may be about 0.1 :99.9 wt% to about 95.2:4.8 wt%, about 50:50 wt% to about 95:5 wt%, or about 60:40 wt% to about 95:5 wt%. When the mixing ratio of the carbon-based active material and the silicon-based active material is within the foregoing range, the volume expansion of the negative active material may be suitably or effectively suppressed or reduced and the conductivity (e.g., electrical conductivity) may be improved.

In the negative active material layer, an amount of the negative active material may be about 95 wt% to about 99.5 wt% based on the total of 100 wt% of the negative active material layer. The amount of the negative active material corresponds to the amount of the silicon-based active material, and in some embodiments, it corresponds to the amount of a mixture, in a case of including a mixture of the silicon-based active material and the carbon-based active material as the negative active material.

The negative active material layer may further include a binder. If the negative active material layer further includes the binder, the negative active material may be included in an amount of about 94 wt% to about 98.9 wt%, the conductive material may be included in an amount of about 0.01 wt% to about 2 wt%, and the binder may be included in an amount of about 1 wt% to about 5 wt% (e.g., based on the total weight of the negative active material layer).

The binder improves binding properties of anode active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may include a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinylpyrrolidone, polyepichlorohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the aqueous binder is used as an anode electrode binder, a cellulose-based compound may be further used to provide viscosity as a thickener. The cellulose-based compound includes one or more of carboxymethyl cellulose, hydroxypropyl methylcellulose, methyl cellulose, and/or alkali metal salts thereof. The alkali metal may be Na, K, and/or Li. The thickener may be included in an amount of about 0.1 parts by weight to about 3 parts by weight based on 100 parts by weight of the anode active material.

The current collector may include one selected from a copper foil, a nickel foil, a stainless steel foil, a titanium foil, a nickel foam, a copper foam, a polymer substrate coated with a conductive metal (e.g., an electrically conductive metal), and a combination thereof, but is not limited thereto.

Another embodiment provides a rechargeable lithium battery including the negative electrode, a positive electrode, and an electrolyte.

The positive electrode includes a current collector and a positive active material layer on the current collector.

A compound capable of intercalating and deintercalating lithium (lithiated intercalation compound) may be used as the cathode active material. In some embodiments, one or more composite oxides of a metal selected from cobalt, manganese, nickel, and a combination thereof, and lithium, may be used. As an example, a compound represented by any one of the following chemical formulas may be used. LiₐA_{1-b}X_{b}D₂ (0.90 ≤ a ≤1.8, 0 ≤ b ≤ 0.5); LiₐA_{1-b}X_{b}O_{2-c}D_{c} (0.90 ≤ a ≤ 1.8, 0 ≤ b ≤ 0.5, 0 ≤ c ≤ 0.05); LiₐE_{1-b}X_{b}O_{2-c}D_{c} (0.90 ≤ a ≤ 1.8, 0 ≤ b ≤ 0.5, 0 ≤ c ≤ 0.05); LiₐE₂₋ _{b}X_{b}O_{4-c}D_{c} (0.90 ≤ a ≤ 1.8, 0 ≤ b ≤ 0.5, 0 ≤ c ≤ 0.05); LiₐNi_{1-b-c}C_{Ob}X_{c}Dₐ (0.90 ≤ a ≤ 1.8, 0 ≤ b ≤ 0.5, 0 ≤ c ≤ 0.5, 0 < α ≤ 2); LiₐNi_{1-b}₋_{c}C_{Ob}X_{c}O₂₋_{α}T_{α} (0.90 ≤ a ≤ 1.8, 0 ≤ b ≤ 0.5, 0 ≤ c ≤0.5, 0 < α < 2); LiₐNi_{1-b-c}C_{Ob}X_{c}O_{2-α}T₂ (0.90 ≤ a ≤ 1.8, 0 ≤ b ≤ 0.5, 0 ≤ c ≤0.5, 0 < α < 2); LiₐNi_{1-b-c}Mn_{b}X_{c}Dₐ (0.90 ≤a ≤1.8, 0 ≤ b ≤ 0.5, 0 ≤ c ≤ 0.5, 0 < α ≤ 2); LiₐNi_{1-b-c}Mn_{b}X_{c}O₂-_{α}T_{α} (0.90 ≤ a ≤ 1.8, 0 ≤ b ≤ 0.5, 0 ≤ c ≤ 0.5, 0 < α < 2); LiₐNi₁₋_{b-c}Mn_{b}X_{c}O₂₋ₐT₂ (0.90 ≤ a ≤ 1.8, 0 ≤ b ≤ 0.5, 0 ≤ c ≤ 0.5, 0 < α < 2); LiₐNi_{b}E_{c}G_{d}O₂ (0.90 ≤ a ≤ 1.8, 0 ≤ b ≤ 0.9, 0 ≤ c ≤0.5, 0.001 ≤ d ≤ 0.1); LiₐNi_{b}C_{Oc}Mn_{d}GₑO₂ (0.90 ≤ a ≤ 1.8, 0 ≤ b ≤ 0.9, 0 ≤ c ≤ 0.5, 0 ≤ d ≤ 0.5, 0 ≤ e ≤ 0.1); LiₐNi_{b}C_{Oc}Al_{d}GₑO₂ (0.90 ≤ a ≤ 1.8, 0 ≤ b ≤ 0.9, 0 ≤ c ≤ 0.5, 0 ≤ d ≤ 0.5, 0 ≤ e ≤ 0.1); LiₐNi_{b}C_{Oc}Mn_{d}GₑO₂ (0.90 ≤ a ≤ 1.8, 0 ≤ b ≤ 0.9, 0 ≤ c ≤ 0.5, 0 ≤ d ≤ 0.5, 0.001 ≤ e ≤ 0.1); LiₐNiG_{b}O₂ (0.90 ≤ a ≤ 1.8, 0.001 ≤ b ≤ 0.1); LiₐC_{O}G_{b}O₂ (0.90 ≤ a ≤ 1.8, 0.001 ≤ b ≤ 0.1); LiₐMn_{1-b}G_{b}O₂ (0.90 ≤ a ≤ 1.8, 0.001 ≤ b ≤ 0.1); LiₐMn₂G_{b}O₄ (0.90 ≤ a ≤1.8, 0.001 ≤ b ≤ 0.1); LiₐMn_{1-g}G_{g}PO₄ (0.90 ≤ a ≤ 1.8, 0 ≤ g ≤ 0.5); QO₂; QS₂; LiQS₂; V₂O₅; LiV₂O₅; LiZO₂; LiNiVO₄; Li _{(3-f)}J₂ PO₄₃ (0 ≤ f ≤ 2); Li _{(3-f)}Fe₂ PO₄₃ (0 ≤ f ≤ 2); LiₐFePO₄ (0.90 ≤ a≤ 1.8)

In the chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on a surface thereof, or may be mixed together with another compound having a coating layer. The coating layer may include at least one coating element compound selected from an oxide of the coating element, a hydroxide of the coating element, an oxyhydroxide of the coating element, an oxycarbonate of the coating element, and a hydroxy carbonate of the coating element. The compound for the coating layer may be amorphous and/or crystalline. The coating element included in the coating layer may include Mg, Al, Co, K, Na, Ca, Si, Ti, V, Sn, Ge, Ga, B, As, Zr, or a mixture thereof. The coating layer may be coated in a method having no (or substantially no) adverse influence on properties of a positive active material by using these elements in the compound. For example, the method may include any suitable coating method (e.g., spray coating, dipping, etc.) generally used in the art, and therefore, further description thereof is not necessary here because it should be readily understood by those skilled in the related field upon reviewing the present disclosure.

In the positive electrode, the amount of the positive active material may be about 90 wt% to about 98 wt% based on the total weight of the positive active material layer.

In an embodiment, the positive active material layer may further include a binder and a conductive material (e.g., an electrically conductive material). Herein, the amount of the binder and the conductive material may be about 1 wt% to about 5 wt%, respectively, based on the total weight of the positive active material layer.

The binder improves binding properties of cathode active material particles with one another and with a current collector. Examples thereof may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity (e.g., electrical conductivity) to the electrode, and any suitable material may be used as long as it does not cause a chemical change in the battery to be configured (e.g., does not cause an undesirable change in the rechargeable lithium battery) and is an electron conductive material (e.g., an electrically conductive material). Examples of the conductive material may include a carbon-based material such as natural graphite, artificial graphite, carbon black, acetylene black, ketjen black, a carbon fiber, and the like; a metal-based material of a metal powder and/or a metal fiber including copper, nickel, aluminum, silver, and the like; a conductive polymer such as a polyphenylene derivative; or a mixture thereof.

The current collector may be an aluminum foil, a nickel foil, or a combination thereof, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethylacetate, methylpropionate, ethylpropionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. Furthermore, the ketone-based solvent includes cyclohexanone and/or the like. The alcohol-based solvent may include ethyl alcohol, isopropyl alcohol, and/or the like, and examples of the aprotic solvent include nitriles such as R-CN (where R is a C2 to C20 linear, branched, and/or cyclic hydrocarbon, and/or including a double bond, an aromatic ring, and/or an ether bond), amides such as dimethylformamide, dioxolanes such as 1 ,3-dioxolane, sulfolanes, and/or the like.

The non-aqueous organic solvent may be used alone or in a mixture of one or more, and when the organic solvent is used in a mixture, the mixture ratio may be controlled in accordance with a suitable or desirable battery performance.

In addition, the carbonate-based solvent is suitably or appropriately used by mixing together a cyclic carbonate and a linear carbonate. When the cyclic carbonate and linear carbonate are mixed together in a volume ratio of about 1:1 to about 1:9 and used, it may have enhanced performance.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed together in a volume ratio of about 1:1 to about 30:1.

The aromatic hydrocarbon-based organic solvent may be an aromatic hydrocarbon-based compound of Chemical Formula 1.

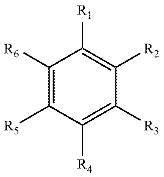

In Chemical Formula 3, R₁ to R₆ are the same or different and are selected from hydrogen, a halogen, a C1 to C10 alkyl group, a haloalkyl group, and a combination thereof.

Examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate, an ethylene carbonate-based compound represented by Chemical Formula 2 as an additive for improving cycle life.

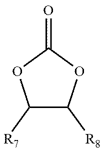

In Chemical Formula 2, R₇ and Rs are the same or different and may each independently be hydrogen, a halogen, a cyano group (CN), a nitro group (NO₂), or a C1 to C5 fluoroalkyl group, provided that at least one of R₇ and Rs is a halogen, a cyano group (CN), a nitro group (NO₂), or a C1 to C5 fluoroalkyl group, and R₇ and R₈ are not simultaneously hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, and/or fluoroethylene carbonate. An amount of the additive for improving the cycle-life characteristics may be used within a suitable or appropriate range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salts selected from LiPF₆, LiBF₄, LiSbF₆, LiAsF₆, LiN(SO₂C₂F₅)₂, Li(CF₃SO₂)₂N, LiN(SO₃C₂F₅)₂, L(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (where x and y are natural numbers, for example, an integer of about 1 to about 20), lithium difluoro(bisoxolato) phosphate), LiCl, Lil, LiB(C₂O₄)₂ (lithium bis(oxalate) borate: LiBOB) and lithium difluoro(oxalate)borate (LiDFOB). A concentration of the lithium salt may be in a range from about 0.1 M to about 2.0 M. When the lithium salt is included at the above concentration range, an electrolyte may have excellent performance and lithium ion mobility due to suitable or optimal electrolyte conductivity and viscosity.

A separator may be between the positive electrode and the negative electrode depending on a type (or kind) of a rechargeable lithium battery. The separator may use polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

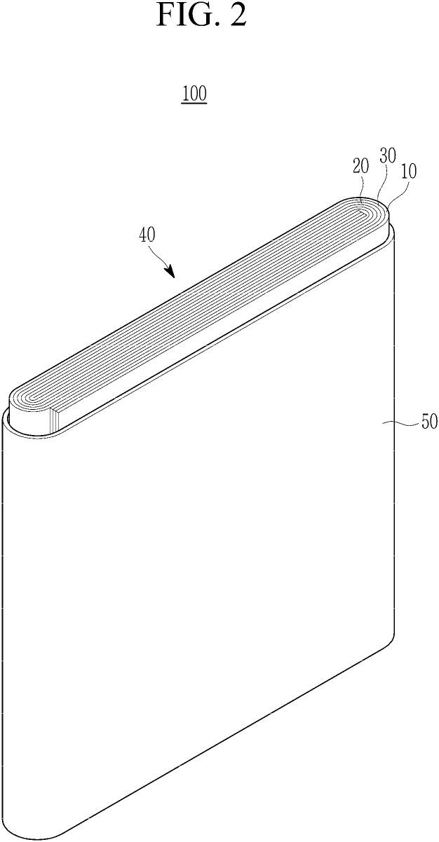

FIG. 2 is an exploded perspective view of a rechargeable lithium battery according to an embodiment. The rechargeable lithium battery according to an embodiment is illustrated as a prismatic battery, but is not limited thereto, and may include variously-shaped batteries such as a cylindrical battery, a pouch battery, and the like.

Referring to FIG. 2, a rechargeable lithium battery 100 according to an embodiment may include an electrode assembly 40 manufactured by winding a separator 30 between a positive electrode 10 and a negative electrode 20 and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Example 1

1 wt% of single-walled carbon nanotubes (average length: 10 µm, average diameter 1 nm to 2 nm) as a conductive material and 1.5 wt% of a polyvinyl pyrrolidone dispersing agent were added to 97.5 wt% of a water solvent and dispersed for 12 hours to prepare a conductive material dispersion having a concentration of 2.5 wt% (e.g., including 2.5 wt% of the single-walled carbon nanotubes based on the total weight of the conductive material dispersion).

A graphite negative active material, a Si-carbon composite (BET specific surface area 5 m²/g) negative active material, the conductive material dispersion, a carboxylmethyl cellulose thickener, and a styrene-butadiene rubber binder were mixed together in a water solvent to prepare a negative active material layer slurry.

In the mixing, the amounts of each material were controlled so that the graphite negative active material was to be 85 wt%, the Si-carbon composite was to be 11 wt%, the single-walled carbon nanotube conductive material was to be 0.05 wt%, the carboxylmethyl cellulose thickener was to be 1.95 wt%, and the styrene-butadiene rubber was to be 2 wt%, as the amounts of the solid, based on the total weight of the solids.

Herein, as the Si-carbon composite, a Si-carbon composite including a core including artificial graphite and silicon particles, and soft carbon coated on a surface of the core, was used. The soft carbon coating layer had a thickness of 20 nm and the silicon particles had an average particle diameter D50 of 100 nm.

The negative active material layer slurry was coated on a copper foil current collector and dried followed by pressing to prepare a negative electrode.

Using the negative electrode, a polyethylene/polypropylene separator, a lithium metal counter electrode, and an electrolyte, a half-cell was fabricated.

The electrolyte was used as 1.5 M LiPF₆ dissolved in a mixed solvent of ethylene carbonate, ethylmethyl carbonate, and dimethyl carbonate (20:10:70 volume ratio).

### Example 2

A negative electrode and a half-cell were prepared by substantially the same procedure as in Example 1, except that 1.2 wt% of the single-walled carbon nanotube (average length: 10 µm, average diameter 1 nm to 2 nm) conductive material and 1.8 wt% of the polyvinyl pyrrolidone dispersing agent were added to 97 wt% of a water solvent and dispersed for 14 hours to prepare a conductive material dispersion having a concentration of 2.5 wt% (e.g., including 2.5 wt% of the single-walled carbon nanotubes based on the total weight of the conductive material dispersion).

### Example 3

A negative electrode and a half-cell were prepared by substantially the same procedure as in Example 1, except that 1.2 wt% of the single-walled carbon nanotube (average length: 10 µm, average diameter 1 nm to 2 nm) conductive material and 1.8 wt% of the polyvinyl pyrrolidone dispersing agent were added to 97 wt% of a water solvent to prepare a conductive material dispersion having a concentration of 2.5 wt% (e.g., including 2.5 wt% of the single-walled carbon nanotubes based on the total weight of the conductive material dispersion).

### Example 4

A negative electrode and a half-cell were prepared by substantially the same procedure as in Example 1, except that 1.2 wt% of the single-walled carbon nanotube (average length: 30 µm to 50 µm, average diameter 1 nm to 2 nm) conductive material and 1.8 wt% of the polyvinyl pyrrolidone dispersing agent were added to 97 wt% of a water solvent and dispersed for 14 hours to prepare a conductive material dispersion having a concentration of 2.5 wt% (e.g., including 2.5 wt% of the single-walled carbon nanotubes based on the total weight of the conductive material dispersion).

### Comparative Example 1

A negative electrode and a half-cell were prepared by substantially the same procedure as in Example 1, except that the dispersion was performed for 30 hours to prepare a conductive material dispersion.

### Comparative Example 2

A negative electrode was prepared by substantially the same procedure as in Example 1, except that the dispersion was performed for 1 hour to prepare a conductive material dispersion.

The prepared negative electrode had a severely uneven surface, so that the cell was unable to be fabricated.

### Comparative Example 3

0.2 wt% of a single-walled carbon nanotube (average length: 10 µm, average diameter 1 nm to 2 nm) conductive material and 0.3 wt% of a polyvinyl pyrrolidone dispersing agent was added to 99.5 wt% of a water solvent and dispersed for 12 hours to prepare a conductive material dispersion having a concentration of 2.5 wt% (e.g., including 2.5 wt% of the single-walled carbon nanotubes based on the total weight of the conductive material dispersion).

Using the conductive material dispersion, a negative active material layer slurry was prepared by substantially the same procedure as in Example 1.

The negative active material layer slurry had a very low viscosity that was insufficient to coat on the current collector, so that the negative electrode was unable to be produced.

### Comparative Example 4

3 wt% of a single-walled carbon nanotube (average length: 10 µm, average diameter 1 nm to 2 nm) conductive material and 4.5 wt% of a polyvinyl pyrrolidone dispersing agent were added to 92.5 wt% of a water solvent. The resulting product had too high of viscosity and was substantially close to a solid, rather than a dispersion, and thus, it could not be used as a dispersion.

### Experimental Example 1) Measurement of Viscosity

The viscosities ata room temperature (25° C.) of the conductive material dispersion of Examples 1 to 4 and Comparative Examples 1 to 4 were measured at a range of shear rate of 0.01 s⁻¹ to 1000 s⁻¹. The results thereof are shown in Table 1.

TABLE 1

| | |
|---|---|
| | Viscosity (cps) |
| Example 1 | 4230 |
| Example 2 | 5650 |
| Example 3 | 5310 |
| Example 4 | 5830 |
| Comparative Example 1 | 12,800 |
| Comparative Example 2 | 500 |
| Comparative Example 3 | 200 |
| Comparative Example 4 | Unable to prepare |

### Experimental Example 2) Measurement of Particle Size Distribution

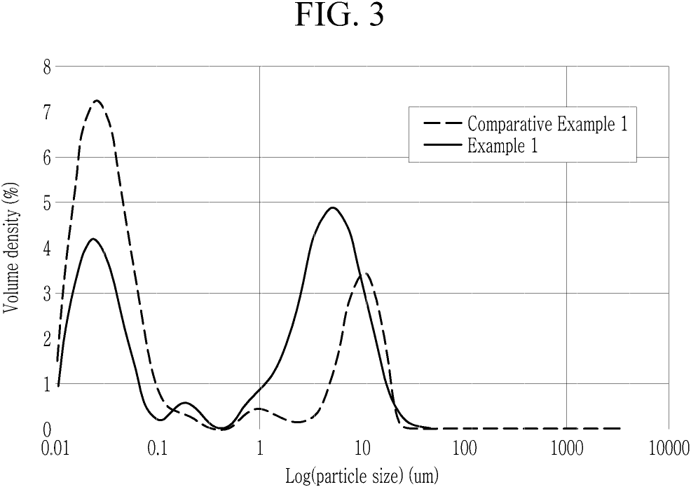

The particle size distribution of the dispersion prepared from Examples 1 to 4 and Comparative Examples 1 to 4 were measured by a laser diffraction (light scattering) method to obtain a maximum peak intensity A occurring in the range of 0.5 µm or less and a maximum peak intensity B occurring in the range of more than 0.5 µm. The results thereof are shown in Table 2. Among the results, the results of Example 1 and Comparative Example 1 are shown in FIG. 3.

Furthermore, from these results, the A/B values were calculated. The results are shown in Table 2.

TABLE 2

| | | | |
|---|---|---|---|
| | A (%) | B (%) | A/B |
| Example 1 | 4.17 | 5.55 | 0.75 |
| Example 2 | 2.06 | 5.56 | 0.37 |
| Example 3 | 2.96 | 4.89 | 0.61 |
| Example 4 | 2.61 | 6.43 | 0.41 |
| Comparative Example 1 | 7.22 | 11.90 | 0.61 |
| Comparative Example 2 | 0.38 | 5.48 | 0.07 |
| Comparative Example 3 | 6.35 | 1.79 | 3.55 |
| Comparative Example 4 | Unmanufactured | Unmanufactured | Unmanufactured |

### Experimental Example 3) Measurement of Cycle-life Characteristic

The half-cells of Examples 1 to 4 and Comparative Examples 2 to 4 were charged and discharged for 50 cycles under the 5 C, 0.01 V, and 0.01 C cut-off charging at 45° C., pausing for 10 minutes, and 1 C, 1.5 V cut-off discharging. A ratio of 50^{th} discharge capacity to 1^{st} discharge capacity was calculated. The results thereof are shown in Table 3 as capacity retention. Comparative Example 1 had too much viscosity (too high of viscosity) as shown in Table 1 so that it is difficult to mass-fabricate a battery, that is, to substantially fabricate a battery, and thus, the cycle-life characteristics measurement was not performed.

TABLE 3

| | |
|---|---|
| | Capacity retention (%) |
| Example 1 | 95.7 |
| Example 2 | 95.6 |
| Example 3 | 95.5 |
| Example 4 | 94.6 |
| Comparative Example 2 | Many grains on surface of coating (unable to assemble cell due to defects of the surface) |
| Comparative Example 3 | Unable to coat the electrode (unable to have viscosity of slurrv) |
| Comparative Example 4 | Unable to fabricate |

As shown in Table 3, Examples 1 to 4 exhibited high battery capacity retention. Whereas, Comparative Example 1 included the conductive material dispersion having the A, the B, and A/B within a range of the present disclosure, but high viscosity of 12,800 cps, so it was difficult to control the preparation and to apply the battery fabrication equipment so that the deviation in the mass production may be increased, thereby causing problems related to battery fabrication.

The negative electrode of Comparative Example 1 using the conductive material dispersion having A/B of 0.07, which was too small had an uneven surface with which it was unable to assemble a battery, that is, to fabricate a battery, so that the capacity retention could not be measured.

Furthermore, in the case of Comparative Example 3 using the conductive material dispersion having A/B of 3.55, which was extremely high, the viscosity of the slurry for the negative active material layer using the same was too low, with which it was unable to produce the negative electrode, so that the capacity retention could not be measured.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the scope of the appended claims and attached drawings of the present disclosure.

What is claimed is:

1. A conductive material dispersion for a rechargeable lithium battery, comprising:
carbon nanotubes,
wherein the conductive material dispersion has a viscosity of about 10,000 cps or less, and
wherein in a graph showing a particle size distribution of the conductive material dispersion,
when A is a maximum peak intensity occurring in a particle size range of about 0.5 µm or less, and B is a maximum peak intensity occurring in a particle size range of more than about 0.5 µm,
the A and the B satisfy a relationship of Equation 1,
Equation 1
A/B < 1.

2. The conductive material dispersion for a rechargeable lithium battery of claim 1, wherein the A/B of Equation 1 is about 0.2 to about 0.8.

3. The conductive material dispersion for a rechargeable lithium battery of claim 1, wherein the conductive material dispersion has a viscosity of about 1000 cps to about 10,000 cps.

4. The conductive material dispersion for a rechargeable lithium battery of claim 1, wherein an amount of the carbon nanotubes is about 0.4 wt% to about 2.0 wt% based on a total of 100 wt% of the conductive material dispersion.

5. The conductive material dispersion for a rechargeable lithium battery of claim 1, wherein the carbon nanotubes are single-walled carbon nanotubes, multi-walled carbon nanotubes, or a combination thereof.

6. The conductive material dispersion for a rechargeable lithium battery of claim 1, wherein the carbon nanotubes have an average length of about 10 µm or less.

7. The conductive material dispersion for a rechargeable lithium battery of claim 1, wherein the carbon nanotubes have an average diameter of about 1 nm to about 5 nm.

8. The conductive material dispersion for a rechargeable lithium battery of claim 1, wherein the A is about 0.1 volume% to about 15 volume% and the B is about 1 volume% to about 20 volume%.

9. A negative electrode for a rechargeable lithium battery prepared by using the conductive material dispersion of claim 1.

10. The negative electrode for a rechargeable lithium battery of claim 9, wherein the negative electrode comprises a silicon and carbon composite negative active material.

11. A rechargeable lithium battery, comprising:
the negative electrode of claim 9,
a positive electrode; and
an electrolyte.
